(19) United States
(12) Patent Application Publication
(10) Pub. No.: US 2005/0145565 A1
(43) Pub. Date: Jul. 7, 2005

(54) Method for preventing the uncontrolled growth of microorganisms

(75) Inventors: Sally Ann Painter, Sydney (AU); Tobias Wirth, Schwabach (DE); David Beddie, Yarpole (GB)

Correspondence Address: MERCHANT & GOULD PC, P.O. BOX 2903, MINNEAPOLIS, MN, 55402-0903, US

(73) Assignee: BETA TEC HOPFENPRODUKTE GMBH, NURNBERG (DE)

(21) Appl. No.: 10/506,134

(22) PCT Filed: Mar. 7, 2003
(86) PCT No.: PCT/DE03/00754

(30) Foreign Application Priority Data
Mar. 7, 2002 (DE) 102 09 934.0

(51) Int. Cl. C02F 3/00

(52) U.S. Cl. 210/610

(57) ABSTRACT

The invention relates to a method for controlling biological processes, particularly digestion processes in water, particularly in stagnant or flowing water systems, whereby a certain quantity of tree resins is added to the water.

The invention relates to a method for controlling biological processes, particularly digestion processes in water, having the additional features of the preamble of patent claim 1.

Known from WO 01/88205 A1 is a method for producing sugar or sugar-containing products from sugar-containing vegetable raw materials, which method is carried out at least partially in the presence of added natural, food-compatible resins. These food-compatible resins can be tree resins, particularly colophony or colophony derivatives. These tree resins serve to inhibit specific microorganisms.

In both stagnant and flowing water systems, the danger of the growth of microorganisms always exists, e.g. of bacteria, fungi, algae, and the like, which growth leads to a considerable lowering of the water quality. This is problematic, for example, in flowing water systems in the food field, in which the water flow is used, for example, to transport the foods.

Chemical agents for avoiding the uncontrolled growth of microorganisms are known, which agents, however, are associated with serious negative secondary effects. For the most part, such chemical substances are toxic for humans and animals. Thus, natural substances possessing the necessary antimicrobial characteristics are preferable.

The object of the present invention is to make available a method for controlling biological processes in water, which method is environmentally friendly, compatible with human health, simple to carry out, and cost-effective.

This object is achieved through the collective teaching of patent claims 1 and 12. Advantageous further developments of the method in question result from the dependent claims 2-11 and 20-22, and, respectively, 13-22.

An advantageous compound for controlling biological processes in water is taught in patent claims 24-26 and 27-28.

In the method according to the invention for controlling biological processes, particularly digestion processes in water, particularly in standing and flowing water systems, a certain amount of tree resins is added to the water. Tree resins can control the growth of microorganisms in water. In this context, the word “control” comprehends both the destruction and removal of micro- and/or macroorganisms. The controlling of the biological processes takes place by means of the tree resins in a purely natural way. In addition, tree resins are quite storable, can be integrated into the process without trouble, and are available in sufficient amounts. The method according to the invention can be applied in the most varied fields, e.g. in the food industry, e.g. in brewery pasteurization; air purifier systems; in the oil industry; fountains; water pipes, water tanks, wastewater systems, wastewater purification, etc.

With particular advantage, colophony and/or colophony derivatives can be used as tree resins. Precisely these resins have proved excellent and especially advantageous in the method for controlling biological processes in water.

In order to ensure an effective control of the biological processes in water, the tree resins, in particular colophony and/or colophony derivatives, are added to the water in an amount of 0.01 mg/l to 10000 mg/l, preferably 0.1 mg/l to 1000 mg/l, especially 1 to 100 mg/l.

The tree resins can be applied in the form of saline solutions or suspensions, preferably as potassium salt solution, especially 0.5 to 35% potassium salt solution, or as sodium salt solution, especially 0.5 to 35% sodium salt solution. Alternatively, the tree resins can be added in the form of other 5 to 20% saline solutions or suspensions.

In addition, it is possible to add the tree resins in the form of alcoholic solution or suspension, preferably as a 1 to 25%, especially 10 to 80% ethanol solution.

Advantageously, the tree resins, or their saline or alcoholic solutions or suspensions, as the case may be, are stabilized prior to their being added to the water. For this purpose, they can be mixed with at least one stabilizing agent, especially with a surface-active agent. Such a stabilization hinders or prevents a precipitation or flocculation of the tree resins before they are added to the water. In addition, the stabilizing agents promote the dispersion of the active components as soon as these are added to the water. The stabilization is especially advantageous in the case of a lengthy storage of large amounts of tree resins or colophony and/or colophony derivatives, so that the capacity to control the biological processes in water is always ensured.

The stabilizing agents can be selected from the group comprising dioctyl sodium sulfosuccinate, sodium monomethyl naphthalene sulfonate and sodium dimethyl naphthalene sulfonate, N-lauroyl sarcosine sodium salt, alkylpolyglycoside, and sodium dodecyl diphenyl oxide disulfonate.

Further, with particular advantage at least one biocide can be added to the water in an effective amount. This can be a matter of, for example, a food-compatible, antimicrobial agent (e.g. hops or hop derivatives). To the class of biocides belong also such agents that prevent the growth or genesis of macroorganisms, as for example mussels or the like. In particular, the biocide can be selected from a group comprising 5-chloro-2-methyl-4-isothiazolin-3-one, 2-methyl-4-isothiazolin-3-one, glutaraldehyde, 2,2-dibromo-3-nitrilopropionamide, 2-bromo-2-nitropropane-1,3-diol, 1-Bromo-1-(bromomethyl)-1,3-propane dicarbonitrile, tetrachloroisophthalonitrile, alkyldimethylbenzylammonium chloride, dimethyldialkylammonium chloride, poly[oxyethylene(dimethyliminio)ethylene(dimethyliminio)ethylene dichloride], methylene bisthiocyanate, 2-decylthioethanamine, tetrakishydroxymethyl phosphonium sulfate, dithiocarbamate, cyanodithioimidocarbonate, 2-methyl-5-nitroimidazole-1-ethanol, 2-(2-bromo-2-nitroethanol)furane, beta-bromo-beta-nitrostyrene, beta-nitrostyrene, beta-nitrovinyl furane, 2-Bromo-2-bromomethylglutaronitrile, bis (trichloromethyl) sulfone, S-(2-hydroxypropyl)thiomethane sulfonate, tetrahydro-3,5-dimethyl-2H-1,3,5-hydrazine-2-thione, 2-(thiocyanomethylthio)benzothiazole, 2-Bromo-4′-hydroxyacetophenone, 1,4-Bis(bromoacetoxy)-2-buten, bis(tributyltin) oxide, copper sulfate, (2-tert-butylamino)-4-chloro-6-ethylamino-s-triazine, dodecylguanidine acetate, dodecylguanidine hydrochloride, coconut alkyldimethylamine oxide, n-coconut alkyltrimethylendiamine, tetraalkyl phosphonium chloride, 7-Oxabicyclo(2.2.1)heptane-2,3-dicarboxylic acid, 2-(4-thiazolyl)benzimidazole, orthophenylphenol, 6-ethoxy-1,2,-dihydro-2,2,4-trimethylquinoline, and 4,5-dichloro-2-n-octyl-4-isothiazolin-3-one.

In order to ensure an effective action of the biocide, the latter can be added to the water in an amount of 0.01 to 10000 mg/l, preferably 0.05 to 50 mg/l, especially 0.1 to 10 mg/l.

In this context, it is equally possible to add a combination of tree resins (especially colophony and/or colophony derivatives) and biocide to the water, or to introduce both components, tree resins and biocide, separately to the water.

According to requirement, the portion of the tree resins can amount to 0.1% to 99%, and in an inverted manner the portion of biocide can likewise amount to 0.1% to 99%.

As already explained above, a certain amount of stabilized tree resins can be added to the water for control of biological processes. This feature once again follows separately from the independent claim 12. Here, the above-described optional features can be additionally realized.

The tree resins or the stabilized tree resins can be added to the water in dry or paste-like or viscous form. The state of aggregation here can be dependent on the stabilizing agent or the saline or alcoholic solutions or suspensions, and can thus be deliberately influenced through these.

The tree resins or stabilized tree resins can appropriately be added to the water at a temperature of −5° C. to 95° C. That is to say, within this temperature range it is possible that organisms can grow if no control of the biological processes takes place.

With a further advantage, the tree resins or stabilized tree resins can be applied in combination with hops or hop derivatives, which are characterized through their antimicrobial property.

Advantageously, hop acid can be added to the water, especial beta acid. A mixture of resin acids, especially tree-resin acids, and beta acids, which in particular are added to the water in a 50:50 ratio, leads to an optimization of the control of biological processes, especially the inhibition of the growth, and the destruction as well as removal of micro- and/or macroorganisms.

The following example is intended to make clear the prevention of algae growth through the use of resin acids, especially tree-resin acids, e.g. colophony acids, and the synergistic effect with beta acids.

First, a pure culture of Chlorella vulgaris fo. viridis was obtained from CCAP (culture collection of algae and protozoa). This culture was then further grown in a fresh and sterile proteose medium. In each case, 20 ml of this substance was filled into glass test tubes and different concentrations of resin acids and/or beta acids were added. After nine days, the chlorophyll pigments were extracted and measured. In the following, when resin acids are mentioned, these are in particular tree-resin acids, advantageously colophony acids.

The data analysis was carried out using Jeffrey's and Humphrey's trichromatic equations. The chlorophyll content of a sample after extraction was determined as 750, 664, 647, and 630 nm through the measurement of OD. The value of 750 nm was subtracted from the absorption values of 644, 647, and 630 nm. The concentrations (mg/l) in the extracted solution of chlorophyll a, b and c₁+c₂ were calculated through use of the 750 nm-corrected absorption values in the following equations:
C_{E,a}=11.85 (Abs 664)−1.54 (Abs 647)−0.08 (Abs 630)
C_{E,b}=21.03 (Abs 647)−5.43 (Abs 664)−2.66 (Abs 630)
C_{E,c}=24.52 (Abs 630)−7.6 (Abs 647)−1.67 (Abs 664)
Where:
C_{E,a}=the concentration (mg/l) of chlorophyll a that was analyzed in the extracted solution
C_{E,b}=the concentration (mg/l) of chlorophyll b that was analyzed in the extracted solution
C_{E,c}=the concentration (mg/l) of chlorophyll c₁+c₂ that was analyzed in the extracted solution
   Results:

Table 1 shows the amount and type of chlorophyll contained in the cultures of Chlorella vulgaris after their treatment with different concentrations of resin and beta acids after an incubation time of nine days. The results show that 1000 ppm of the resin acids significantly reduced the chlorophyll portion of a sample, which is a clear indication of algae-inhibiting activity.

A mixture of 50 ppm resin acids and 50 ppm beta acids reduced the chlorophyll portion of a sample more than in the case of a separate introduction in each case of 100 ppm of each of the biocides. This shows the synergistic action between the two components resin acid and beta acid.

TABLE 1

| | Concentration of chlorophyll in the samples after an | | |
|---|---|---|---|
| Concentration | incubation time of 9 days [mg/l] | | |
| of biocides | | | Chlorophyll c₁ + |
| [ppm] | Chlorophyll a | Chlorophyll b | c₂ |
| Control solution | 10.12 | 4.43 | 3.42 |
| (without addition) | | | |
| 100 ppm resin acid | 11.31 | 4.6 | 3.4 |
| 1000 ppm resin acid | 2 | 1.25 | 1.26 |
| 100 ppm beta acid | 9.3 | 3.83 | 2.76 |
| 1000 ppm beta acid | 3.34 | 1.8 | 1.47 |
| 50 ppm resin | 7.04 | 2.83 | 1.8 |
| acid + 50 ppm | | | |
| beta acid | | | |

The following example shows the prevention of gram-positive bacteria through the use of resin acids:

Two strains of the bacteria species Bacillus stearothermophilus, DSM 22 and DSM 457, a gram-positive bacteria species, were grown at 55° C. on a culture medium that contained known concentrations of resin acids. The percentage growth of the bacteria was measured in comparison to a control substance without any resin acids.

The results show that the concentrations of resin acids in a range of 1 to 5 ppm have a significant influence on the prevention/retardation of the growth of the two bacteria strains.

The following table shows the results of this test:

| | |
|---|---|
| | Percentage growth of bacteria |
| Concentration | in comparison to the control |
| of the | solution [%] |

| resin acids [ppm] | DSM 22 | DSM 457 |
|---|---|---|
| 0 ppm | 100 | 100 |
| (Control Solution) | | |
| 1 ppm | 90.1 | 6.4 |
| 2 ppm | 61.6 | 5.1 |
| 3 ppm | 56.2 | 3.9 |
| 4 ppm | 0 | 1.3 |
| 5 ppm | 0 | 0 |

Arising from the independent patent claim 23 is the advantageous use of tree resins in the controlling of biological processes in water, particularly digestion processes in standing or flowing water systems.

An advantageous compound for controlling biological processes in water is described in the independent patent claims 24 and 27. According to patent claim 24, the compound contains a certain amount of tree resins. Colophony and/or colophony derivatives can be provided as the tree resins. Possible additional features of the compound result from the above-described method.

According to patent claim 27, the compound contains a certain amount of stabilized tree resins. With respect to the optional features, reference is likewise made to the above-described method.

1. Method for controlling digestion processes in water, particularly in standing or flowing water systems, wherein a certain amount of colophony is added to the water.

2. Method according to claim 1, wherein in addition to colophony, colophony derivatives are also applied.

3. Method according to one of the claims 1, wherein the colophony and/or the colophony derivatives are added to the water in an amount of 0.01 to 10000 mg/l, preferably 0.1 to 1000 mg/l, especially 1 to 100 mg/l.

4. Method according to claim 1, wherein the colophony and/or the colophony derivatives are applied in the form of saline solutions or suspensions, preferably as potassium salt solution, especially 0.5 to 35% potassium salt solution, or as sodium salt solution, especially 0.5 to 35% sodium salt solution.

5. Method according to claim 1, wherein the colophony and/or the colophony derivatives are added in the form of 5 to 20% saline solutions or suspensions.

6. Method according to claim 1, wherein the colophony and/or the colophony derivatives are added in the form of alcoholic solution or suspension, preferably a 1 to 95%, especially 10 to 80% ethanol solution.

7. Method according to claim 1, wherein the colophony and/or the colophony derivatives or, as the case may be, their saline or alcoholic solutions or suspensions, are mixed with at least one stabilizing agent, especially a surface-active agent, prior to their addition to the water.

8. Method according to claim 7, wherein the stabilizing agent is selected from the group comprising dioctyl sodium sulfosuccinate, sodium monomethyl naphthalene sulfonate and sodium dimethyl naphthalene sulfonate, N-lauroyl sarcosine sodium salt, alkylpolyglycoside, and sodium dodecyl diphenyl oxide disulfonate.

9. Method according to claim 1, wherein at least one biocide is added in effective amount to the water.

10. Method according to claim 9, wherein the biocide is selected from the group comprising 5-chloro-2-methyl-4-isothiazolin-3-one, 2-methyl-4-isothiazolin-3-one, glutaraldehyde, 2,2-dibromo-3-nitrilopropionamide, 2-bromo-2-nitropropane-1,3-diol, 1-Bromo-1-(bromomethyl)-1,3-propane dicarbonitrile, tetrachloroisophthalonitrile, alkyldimethylbenzylammonium chloride, dimethyldialkylammonium chloride, poly[oxyethylene(dimethyliminio)ethylene(dimethyliminio)ethylene dichloride], methylene bisthiocyanate, 2-decylthioethanamine, tetrakishydroxymethyl phosphonium sulfate, dithiocarbamate, cyanodithioimidocarbonate, 2-methyl-5-nitroimidazole-l-ethanol, 2-(2-bromo-2-nitroethanol) furane, beta-bromo-beta-nitrostyrene, beta-nitrostyrene, beta-nitrovinyl furane, 2-Bromo-2-bromomethylglutaronitrile, bis (trichloromethyl) sulfone, S-(2-hydroxypropyl)thiomethane sulfonate, tetrahydro-3,5-dimethyl-2H-1,3,5-hydrazine-2-thione, 2-(thiocyanomethylthio)benzothiazole, 2-Bromo-4′-hydroxyacetophenone, 1,4-Bis(bromoacetoxy)-2-buten, bis(tributyltin) oxide, copper sulfate, (2-tert-butylamino)-4-chloro-6-ethylamino-s-triazine, dodecylguanidine acetate, dodecylguanidine hydrochloride, coconut alkyldimethylamine oxide, n-coconut alkyltrimethylendiamine, tetraalkyl phosphonium chloride, 7-Oxabicyclo(2.2.1 )heptane-2,3-dicarboxylic acid, 2-(4-thiazolyl)benzimidazole, orthophenylphenol, 6-ethoxy-1,2,-dihydro-2,2,4-trimethylquinoline, and 4,5-dichloro-2-n-octyl-4-isothiazolin-3-one.

11. Method according to claim 9, wherein the biocide is added to the water in an amount of 0.01 to 10000 mg/l, preferably 0.05 to 50 mg/l, especially 0.1 to 10 mg/l.

12. Method for controlling digestion processes in water, particularly in standing or flowing water systems, wherein a certain amount of stabilized colophony is added to the water for the enhancement of its chemical stability.

13. Method according to claim 12, wherein, in addition, stabilized colophony derivatives are added for the enhancement of their chemical stability.

14. Method according to claim 13, wherein the colophony and/or the colophony derivatives are stabilized by means of at least one surface-active agent.

15. Method according to claim 1, wherein the stabilizing agent is selected from the group comprising dioctyl sodium sulfosuccinate, sodium monomethyl naphthalene sulfonate and sodium dimethyl naphthalene sulfonate, N-lauroyl sarcosine sodium salt, alkylpolyglycoside, and sodium dodecyl diphenyl oxide disulfonate.

16. Method according to claim 12, wherein the stabilized colophony and/or the stabilized colophony derivatives are added to the water in an amount of 0.01 to 10000 mg/l, preferably 0.1 to 1000 mg/l, especially 1 to 100 mg/l.

17. Method according to claim 12, wherein at least one biocide is added in effective amount to the water.

18. Method according to claim 17, wherein the biocide is selected from the group comprising 5-chloro-2-methyl-4-isothiazolin-3-one, 2-methyl-4-isothiazolin-3-one, glutaraldehyde, 2,2-dibromo-3-nitrilopropionamide, 2-bromo-2-nitropropane-1,3-diol, 1-Bromo-1-(bromomethyl)-1,3-propane dicarbonitrile, tetrachloroisophthalonitrile, alkyldimethylbenzylammonium chloride, dimethyldialkylammonium chloride, poly[oxyethylene(dimethyliminio)ethylene(dimethyliminio)ethylene dichloride], methylene bisthiocyanate, 2-decylthioethanamine, tetrakishydroxymethyl phosphonium sulfate, dithiocarbamate, cyanodithioimidocarbonate, 2-methyl-5-nitroimidazole-l-ethanol, 2-(2-bromo-2-nitroethanol) furane, beta-bromo-beta-nitrostyrene, beta-nitrostyrene, beta-nitrovinyl furane, 2-Bromo-2-bromomethylglutaronitrile, bis (trichloromethyl) sulfone, S-(2-hydroxypropyl)thiomethane sulfonate, tetrahydro-3,5-dimethyl-2H-1,3,5-hydrazine-2-thione, 2-(thiocyanomethylthio)benzothiazole, 2-Bromo-4′-hydroxyacetophenone, 1,4-Bis(bromoacetoxy)-2-buten, bis(tributyltin) oxide, copper sulfate, (2-tert-butylamino)-4-chloro-6-ethylamino-s-triazine, dodecylguanidine acetate, dodecylguanidine hydrochloride, coconut alkyldimethylamine oxide, n-coconut alkyltrimethylendiamine, tetraalkyl phosphonium chloride, 7-Oxabicyclo(2.2. 1)heptane-2,3-dicarboxylic acid, 2-(4-thiazolyl)benzimidazole, orthophenylphenol, 6-ethoxy-1,2,-dihydro-2,2,4-trimethylquinoline, and 4,5-dichloro-2-n-octyl-4-isothiazolin-3-one.

19. Method according to claim 14, wherein the biocide is added to the water in an amount of 0.01 to 10000 mg/l, preferably 0.05 to 50 mg/l, especially 0.1 to 10 mg/l.

20. Method for controlling digestion processes in water, particularly in standing or flowing water systems, wherein a certain amount of stabilized colophony is added to the water for the enhancement of its chemical stability, and wherein at least one of the features of claim 4 is realized for the stabilized colophony or the stabilized colophony derivatives.

21. Method according to claim 1, wherein colophony and/or the colophony derivatives and/or the stabilized colophony and/or the stabilized colophony derivatives are added in dry or paste-like or viscous form.

22. Method according to claim 1, wherein the colophony and/or the colophony derivatives and/or the stabilized colophony and/or the stabilized colophony derivatives are added to the water at a temperature of −5° C. to 95° C.

23. Method according to claim 1, wherein the colophony and/or the colophony derivatives and/or the stabilized colophony and/or the stabilized colophony derivatives are applied in combination with hops or hop derivatives.

24. Application of colophony in the control of digestion processes in standing or flowing water systems.

25. Application according to claim 24, wherein, in addition, colophony derivatives are applied.

26. Compound for controlling digestion processes in standing or flowing water systems, wherein the compound contains a certain amount of colophony.

27. Compound according to claim 26, wherein in addition to colophony, colophony derivatives are also provided.

28. Compound for controlling digestion processes in standing or flowing water systems, wherein the compound contains a certain amount of colophony, and wherein at least one of the features of claim 3 is realized.

29. Compound for controlling digestion processes in standing or flowing water systems, wherein the compound contains a certain amount of stabilized colophony for the enhancement of its chemical stability.

30. Compound according to claim 29, wherein the compound contains a certain amount of stabilized colophony for the enhancement of its chemical stability.

31. Compound for controlling digestion processes in standing or flowing water systems, wherein the compound contains a certain amount of stabilized colophony for the enhancement of its chemical stability, and wherein at least one of the features of claim 3 is realized.
